(19) United States
(12) Patent Application Publication
(10) Pub. No.: US 2025/0263177 A1
(43) Pub. Date: Aug. 21, 2025

(54) METHOD AND SYSTEM FOR ESTIMATING AIR FLOW THROUGH AN AIRCRAFT AIR VENT

(71) Applicant: Airbus Operations SAS, TOULOUSE (FR)

(72) Inventors: Thomas STEVENS, TOULOUSE (FR); Frederic TOST, TOULOUSE (FR); Atef GHALAYINI, BLAGNAC (FR); Benoit PARCELIER, TOULOUSE (FR)

(21) Appl. No.: 19/057,137

(22) Filed: Feb. 19, 2025

(30) Foreign Application Priority Data
Feb. 20, 2024 (FR) 2401664

(51) Int. Cl. B64D 43/00; G01F 1/34; G01F 25/10

(52) U.S. Cl. CPC B64D 43/00; G01F 1/34; G01F 25/10

(57) ABSTRACT

A method for estimating the air flow through an aircraft air vent, having at least two pressure sensors positioned along a pressure measurement extraction line on or near a lip of the vent, by calibration and correlation steps. The calibration step comprises generating a database associating, for each of at least two air streams applied to the vent, values of at least two known air stream characteristics, and the pressure distribution measurements along the measurement extraction line. The correlation step comprises measuring a pressure distribution along the line when the aircraft is in flight; and correlating the measured pressure distribution, associated with the values of the two characteristics, with the data from the database, in order to estimate the air flow when the aircraft is in flight.

### CROSS-REFERENCES TO RELATED APPLICATIONS

This application claims the benefit of French Patent Application Number 2401664 filed on Feb. 20, 2024, the entire disclosure of which is incorporated herein by way of reference.

### FIELD OF THE INVENTION

The present invention relates to estimating the air flow through an aircraft air vent, and more particularly to a method and a system for estimating this air flow implementing sensors positioned on or near a lip of the air vent.

### BACKGROUND OF THE INVENTION

The drag of an aircraft is generally determined through evaluating the thrust of the engine. The thrust of the engine cannot be measured in flight, and is estimated through a model, using the air flow through an air intake of the engine as a key parameter. This is notably the case during in-flight tests, where, for evaluating the performance of the aircraft, the air flow of the engine must be calculated in flight in order to evaluate the thrust of the engine correctly.

For other applications, such as cooling or ventilation systems, accurately knowing the air flow is essential for validating the system, troubleshooting, certification and predicting the impact on the drag of the aircraft.

On turbojets, the air flow of the secondary stream is generally evaluated in order to determine an average total pressure of the fan nozzles. The air flow is generally derived from this pressure ratio of the fan nozzles combined with the coefficients of the fan nozzles which are determined by wind tunnel tests or ground tests.

The limitations of these techniques are notably the installation and maintenance time, which is often extended.

The techniques alluded to in this section should not be presumed to belong to the prior art just because they are alluded to. Likewise, a problem mentioned in this same section should not be presumed to have been previously identified in the prior art just because it is mentioned.

### SUMMARY OF THE INVENTION

Embodiments of the present invention have been developed on the basis of the developers' understanding of the gaps associated with the prior art. The present invention thus comprises, in various embodiments, a method for estimating the air flow through an aircraft air vent, at least two pressure sensors being positioned along a pressure measurement extraction line on or near a lip of the air vent, the method comprising:
a calibration step comprising
applying at least two air streams to the air vent successively, each air stream having at least two characteristics, one of which is of velocity and one of incidence of the air stream with respect to the air vent, the values of the at least two characteristics of each air stream being known;
for each of the at least two air streams applied to the air vent, measuring a corresponding pressure distribution along the measurement extraction line; and
generating a reference database associating, respectively, for each of the at least two air streams applied to the air vent, the values of the at least two characteristics and the pressure distribution measurements along the measurement extraction line; and
a correlation step, comprising: measuring a pressure distribution along the measurement extraction line when the aircraft is in flight; and correlating the measured pressure distribution, associated with the values of the at least two characteristics of the air stream passing through the air vent in flight, with the data from the reference database, in order to estimate the air flow passing through the air vent when the aircraft is in flight.

In one implementation of the method, at least one of the at least two air streams of the calibration step is applied by an actual physical test to the air vent.

In another implementation of the method, at least one of the at least two air streams of the calibration step is applied to the air vent by computer simulation.

In another implementation of the method, correlating the measured pressure distribution with the data from the reference database comprises an extrapolation.

In another implementation of the method, the calibration step comprises: using all or some of the information from the reference database in order to feed a neural network, and training it by machine learning; and the correlation step comprises: feeding the trained neural network with the measured pressure distribution associated with the values of the at least two characteristics of the air stream passing through the air vent in flight, the trained model inferring the estimate of the air flow passing through the air vent when the aircraft is in flight.

The present invention also comprises, in various embodiments, a processor-readable medium, comprising instructions for executing the above method.

The present invention also comprises, in various embodiments, an aircraft air vent, at least two pressure sensors being positioned along a pressure measurement extraction line on or near a lip of the air vent, the air vent being equipped with a reference database obtained by a calibration step comprising:
applying at least two air streams to the air vent successively, each air stream having at least two characteristics, one of which is of velocity and one of incidence of the air stream with respect to the air vent, the at least two air stream characteristics being known;
for each of the at least two air streams applied to the air vent, measuring a corresponding pressure distribution along the measurement extraction line; and
generating a reference database associating, respectively, for each of the at least two air streams applied to the air vent, the values of the at least two characteristics and the pressure distribution measurements along the measurement extraction line.

In one implementation of the air vent, the at least two pressure sensors have a minimal projection with respect to the lip of the air vent.

In one implementation of the air vent, the at least two pressure sensors are ultra-fine pressure sensors embedded in the perforated lip of the air vent.

In one implementation of the air vent, the at least two pressure sensors are pressure sensors of the pneumatic type.

The present invention also comprises, in various embodiments, a system comprising a processor configured to execute the above method.

The present invention finally comprises, in various embodiments, an aircraft comprising an air vent as above, to which a correlation step is applied, comprising: measuring a pressure distribution along the measurement extraction line when the aircraft is in flight;
correlating the measured pressure distribution, associated with the values of the at least two characteristics of the air stream passing through the air vent in flight, with the data from the reference database, in order to estimate the air flow passing through the air vent when the aircraft is in flight.

### BRIEF DESCRIPTION OF THE DRAWINGS

For a better understanding of the present invention, reference is made to the following description, which must be used in conjunction with the attached drawings, where:

FIG. 1a depicts a perspective view of an air inlet on an aircraft engine;

FIG. 1b depicts a detailed perspective view of an air vent equipped with pressure sensors;

FIG. 1c depicts pressure sensors positioned along a pressure measurement line according to one embodiment;

FIG. 2 depicts a graph with pressure values measured at each of the sensors of the pressure measurement line, for four flight cases and air streams with known characteristics;

FIG. 3 illustrates the steps of a method according to the invention;

FIG. 4a depicts a sectional view of a pressure sensor with a minimum projection with respect to a lip of the air vent;

FIG. 4b depicts a sectional view of an ultra-fine pressure sensor embedded in the perforated lip of the air vent;

FIG. 4c depicts a sectional view of a pressure sensor of the conventional pneumatic type;

FIG. 5 illustrates a computer system which can be used in the present invention; and,

FIG. 6 depicts a perspective view of an aircraft equipped with an air vent for which the present invention can be applied.

It should be noted that, unless explicitly stated otherwise herein, the drawings are not to scale. Finally, elements which are identical from one drawing to another bear the same numerical reference.

### BRIEF DESCRIPTION OF THE PREFERRED EMBODIMENTS

In what follows, measurement data emitted by a sensor are to be understood as a set of a plurality of measurement data emitted by said sensor.

In the context of the present description, unless expressly provided for otherwise, a “processor” may refer to, but without being limited to, any type of “computer system”, “electronic device”, “computerized system”, “control unit”, “monitoring device”, “server” and/or any combination thereof appropriate to the task in question, in connection with the reception, storage, processing and/or transmission of data.

In the context of the present description, the expression “FPGA” is intended to include systems of the field-programmable gate array type, which are available on the market at the time of filing of the present patent application, such as the references Xilinx VU9P or Intel Stratix V, and all subsequent equivalent inventions which have become available, whatever their name, consisting of computer system hardware which can be programmed with software.

In the context of the present description, a “processor” may comprise a single dedicated processor, a single shared processor, or a plurality of individual processors, some of which may be shared. A “processor” may be a general-purpose processor, such as a central processing unit (CPU), a purpose-specific processor or a processor implemented in an FPGA. Other, conventional and/or customized, hardware and software may also be included in a “processor”.

In the context of the present description, unless expressly provided for otherwise, the expression “memory” includes random-access storage systems, which are available on the market at the time of filing of the present patent application, and all subsequent equivalent inventions which become available, whatever their denomination, consisting of computer system media for storing digital information. An example of such a memory may be a static random-access memory (SRAM).

In the context of the present description, the functional steps depicted in the figures can be performed by using dedicated hardware, as well as hardware which is capable of executing appropriate software.

In the context of the present description, unless expressly provided for otherwise, the words “first”, “second”, “third”, etc. have been used as adjectives only for the purpose of making it possible to distinguish the nouns they accompany from one another, not with the aim of describing a particular relationship between these nouns.

The implementations of the present invention each have at least one of the objects and/or aspects mentioned above, but do not necessarily have all of them.

Additional and/or alternative features, aspects and advantages of the implementations of the present invention will emerge from the following description, from the attached drawings and from the appended claims.

The examples and the associated conditions detailed here are mainly intended to help the reader understand the principles of the present invention and not to limit its scope to these specific examples and conditions. It will be understood that a person skilled in the art can conceive of various arrangements which, although they are not explicitly described or depicted here, nevertheless embody the principles of the present invention and are included in its spirit and its scope.

In addition, in order to facilitate understanding, the following description may describe relatively simplified implementations of the present invention. As a person skilled in the art understands, other implementations of the present invention may be of greater complexity.

In certain cases, examples of modifications of the present invention may also be presented. This is done simply as an aid to understanding, and, again, not to define the scope or establish the limits of the present invention. These modifications are not an exhaustive list, and a person skilled in the art may make other modifications while at the same time remaining within the scope of the present invention.

In addition, all the statements below relating to the principles, aspects and implementations of the present invention, as well as the specific examples thereof, are intended to encompass both the structural and functional equivalents thereof, whether they are currently known or developed in the future. Thus, for example, it will be understood by a person skilled in the art that all the block diagrams depict conceptual views of examples of circuits incorporating the principles of the present invention. Likewise, it will be well understood that all the flowcharts, state transition diagrams, pseudo-code, and the like, depict various processes which can be implemented on computer-readable media, and thus be executed by a computer or a processor, whether such a computer or processor is shown in the figures or not.

The functions of the various elements depicted in the figures, including any functional block, can be performed by the use of dedicated hardware as well as hardware which is capable of executing appropriate software. They can also be executed by a processor. Other, conventional and/or customized, hardware may also be used.

Software modules, or modules which are assumed to be software, can be depicted here as a combination of flowchart elements, or other elements indicating the execution of the steps of a process, and/or as a textual description. Such modules can be executed by hardware which is expressly depicted or not. In addition, it should be understood that “module” may include, for example, but without being limited to, computer program logic, computer program instructions, software, software stack, firmware, hardware circuitry, or a combination of these various elements which provides the required capabilities.

That said, a few non-limiting examples will now be considered in order to illustrate various implementations of the present invention.

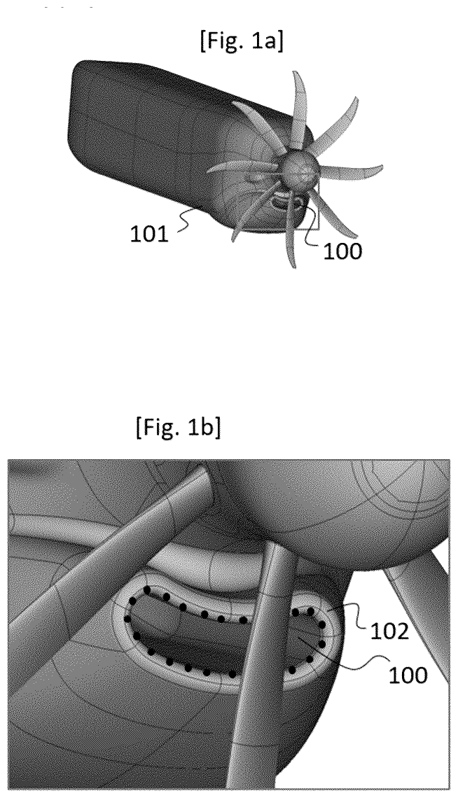

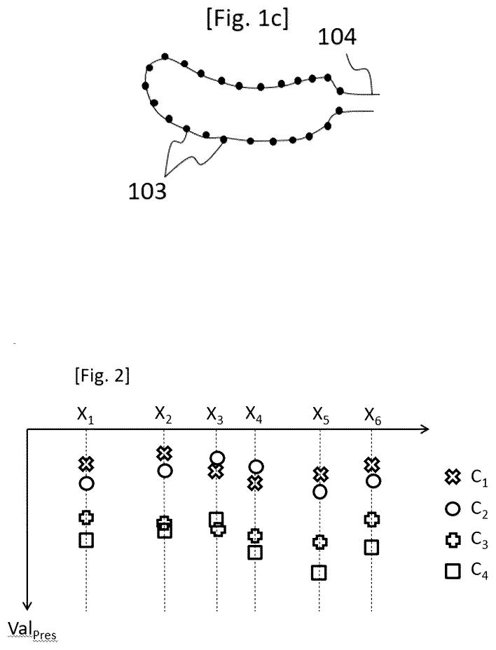

In one example, and in accordance with FIGS. 1a, 1b and 1c, the invention is applied to the air inlet 100 of the cooling system of an aircraft engine 101. At least two pressure sensors 103 positioned along a pressure measurement extraction line 104 are positioned on or near the lip 102 of the air inlet 100.

The invention can be applied generally to any air inlet with which an aircraft is equipped, whether for propulsion systems with a compressor, such as auxiliary power units (APUs), or more passive systems using the energy of the external air flow in order to cool or ventilate an area/a component of the aircraft. The invention can also be applied to any air vent with which an aircraft is equipped. All of these aircraft air inlets and vents are collectively referred to as an “air vent”.

The invention proposes a non-intrusive solution for estimating the air flow passing through an air vent, equipped with at least two pressure sensors 103 positioned along a pressure measurement extraction line 104, on or near the lip 102 of the air vent, for example, the air inlet 100. The solution consists in exploiting the pressure measurement distribution information from the pressure sensors 103 along the pressure measurement extraction line 104, and includes:
a calibration step: two air streams with known characteristics (notably including velocity and incidence) are applied to the air vent by actual physical tests (for example wind tunnel tests, ground tests, etc.), or by computer simulation (for example numerical simulation of fluid flows, etc.); for each air stream, the pressure measurement value from the pressure sensors 103 along the pressure measurement extraction line 104 is recorded, making it possible to establish a reference database to be established;
a step of in-flight correlation (understood throughout this application as an “actual” or wind tunnel flight) of the aircraft: an air stream with known characteristics (notably including velocity and incidence) then passes through the air vent; the pressure measurement value from the pressure sensors 103 along the pressure measurement extraction line 104 is recorded, and correlated with the information from the reference database, in order to derive therefrom an estimate of the air flow actually passing through the air vent. The correlation step can be carried out, for example, by extrapolation, machine learning, etc.

In one example, the invention comprises only the calibration step, when it is implemented by a manufacturer of a system comprising an air vent, which sells, as a supplier, this system to an aircraft manufacturer. In this case, the supplier delivers, with the system sold, the information resulting from the calibration step (i.e., the reference database), making it possible for the aircraft manufacturer to proceed to the step of in-flight correlation of the aircraft.

When an aircraft is in flight, a certain number of measurements (Alpha, Beta, Mach, Pitch, RPM, etc.) are available and known. These measurements characterize the air stream passing through an air vent with which the aircraft is equipped, the air vent notably being positioned at a certain angle with respect to the flight trajectory. These same characteristics can be emulated during the calibration step, through characteristics of the at least two air streams applied to the air vent.

Thus, during the calibration step, at least two “flight cases” are defined, each flight case being associated with at least two characteristics of the air stream applied to the air vent, and which emulate the same two characteristics of an actual flight. For each flight case in calibration mode, the pressure measurements provided by the pressure sensors 103 are recorded along the pressure measurement extraction line 104.

Thus, at the end of the calibration step, a Table 1 (as an example of an implementation of a reference database) below can be established, in a simplified example where:
four flight cases C₁-C₄ are emulated;
the pressure measurement extraction line is equipped with six pressure sensors, positioned respectively at an abscissa X₁-X₆ along this line;
each flight case Cⱼ corresponding to four respective values ValCarᵢⱼ of four flight characteristics Car₁;
for each flight case Cⱼ, the pressure values at six respective abscissa values Xₖ are measured and recorded: ValPresⱼₖ.

TABLE 1

| | | | | | Curvilinear abscissa along the pressure measurement | | | | | |
|---|---|---|---|---|---|---|---|---|---|---|
| Flight | Flight characteristics | | | | extraction line 104 | | | | | |
| case | Car₁ | Car₂ | Car₃ | Car₄ | X₁ | X₂ | X₃ | X₄ | X₅ | X₆ |
| C₁ | Val | Val | Val | Val | Val_{Pres11} | Val_{Pres12} | Val_{Pres13} | Val_{Pres14} | Val_{Pres15} | Val_{Pres16} |
| | Car₁₁ | Car₁₂ | Car₁₃ | Car₁₄ | | | | | | |
| C₂ | Val | Val | Val | Va | Val_{Pres21} | Val_{Pres22} | Val_{Pres23} | Val_{Pres24} | Val_{Pres25} | Val_{Pres26} |
| | Car₂₁ | Car₂₂ | Car₂₃ | Car₂₄ | | | | | | |
| C₃ | Val | Val | Val | Val | Val_{Pres31} | Val_{Pres32} | Val_{Pres33} | Val_{Pres34} | Val_{Pres35} | Val_{Pres36} |
| | Car₃₁ | Car₃₂ | Car₃₃ | Car₃₄ | | | | | | |
| C₄ | Val | Val | Val | Val | Val_{Pres41} | Val_{Pres42} | Val_{Pres43} | Val_{Pres44} | Val_{Pres45} | Val_{Pres46} |
| | Car₄₁ | Car₄₂ | Car₄₃ | Car₄₄ | | | | | | |

FIG. 2 depicts a graph corresponding to the information from Table 1. The horizontal axis corresponds to the curvilinear abscissa along the air vent, with six respective values X₁-X₆. The vertical axis corresponds to the respective pressure measurement for each of the six sensors located at the abscissae X₁-X₆. The values are indicated for each of the four flight cases C₁-C₄. In addition, a value ValCar for each of the four characteristics Car₁-Car₄ corresponds to each flight case. The information is therefore associated between the flight characteristic values ValCarᵢⱼ and the pressure values ValPresⱼₖ along the pressure measurement extraction line 104.

Each of the flight cases C1-C4 may correspond to an actual physical test, or a computer simulation.

In one example, the calibration step comprises using all or some of the information from Table 1 in order to feed a model, for example a neural network, and train it by machine learning.

The correlation step notably comprises measuring a pressure distribution along the measurement extraction line when the aircraft is in flight, in association with known flight characteristics (Alpha, Beta, Mach, Pitch, RPM, etc.), then correlating the pressure distribution measured when the aircraft is in flight, associated with these known flight characteristics, with the data and values from Table 1, in order to estimate the air flow passing through the air vent when the aircraft is in flight. A person skilled in the art knows how to carry out this correlation step, for example by extrapolation, etc., or by using, in inference mode, the aforementioned trained model.

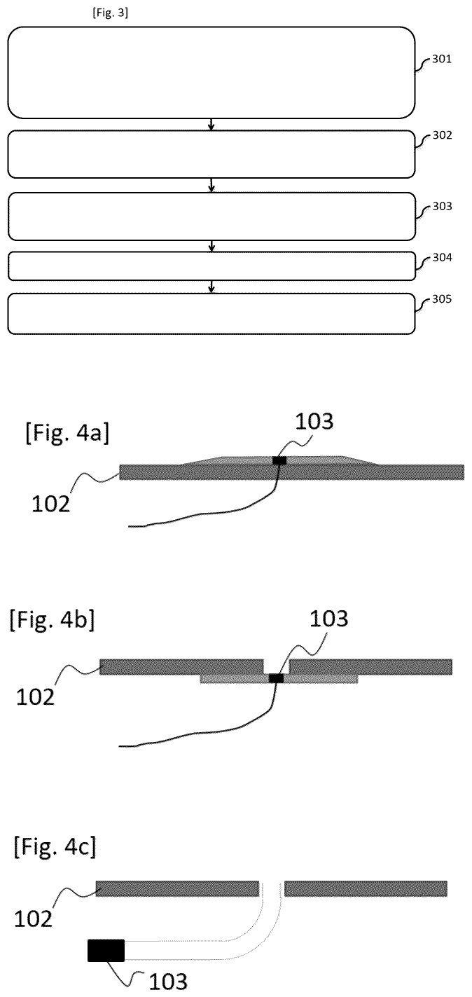

FIG. 3 illustrates the steps of a method according to the invention. In the step 301, the method comprises applying at least two air streams to an air vent (100) successively, each air stream having at least two known characteristics, one of which is of velocity, and one of incidence of the air stream with respect to the air vent, at least two pressure sensors (103) being positioned along a pressure measurement extraction line (104) on or near a lip (102) of the air vent.

In the step 302, the method also comprises, for each of the at least two air streams applied to the air vent, measuring a corresponding pressure distribution along the measurement extraction line.

In the step 303, the method also comprises generating a database associating respectively, with the known characteristics of each of the at least two air streams applied to the air vent, a pressure distribution along the measurement extraction line.

In the step 304, the method also includes measuring a pressure distribution along the measurement extraction line when the aircraft is in flight.

In the step 305, the method also comprises correlating the pressure distribution measured when the aircraft is in flight, associated with known flight characteristics, with the data from the database, in order to estimate the air flow passing through the air vent when the aircraft is in flight.

In one example, the correlation step comprises feeding a model trained by machine learning during the calibration step with the data from the pressure distribution measured when the aircraft is in flight, associated with the known flight characteristics, the trained model inferring the estimate of the air flow passing through the air vent when the aircraft is in flight.

In one example, the calibration step was carried out with a measurement extraction line 104 comprising 400 points, i.e.: 400 pressure sensors 103, and 24 flight cases C₁-C₂₄ each combining 4 characteristics Car₁-Car₄. These data were used to train a neural network. In the in-flight correlation step, the trained neural network estimated the air flow passing through the air vent 100 with an accuracy of 0.5%.

The invention implements, for example, one or other of the pressure sensors 103 referred to in FIGS. 4a, 4b and 4c. The pressure sensors 103 must be capable of evaluating the local static pressure along the pressure measurement extraction line 104 when they are positioned on or near the lip 102. FIG. 4a illustrates the case of a pressure sensor 103 with a minimum projection with respect to the lip 102, for example through an ultra-fine pressure sensor, for example of the MEMS (microelectromechanical systems) type. FIG. 4b illustrates the case of an ultra-fine pressure sensor 103 embedded in the perforated lip 102. FIG. 4c illustrates the case of a pressure sensor 103 of the conventional pneumatic type. Thus, the sensors 103 adapted for the invention can be more or less flush with the surface of the lip 102; a person skilled in the art knows how to adapt the calibration step accordingly.

FIG. 5 illustrates a computer system which can be used in the present invention, for example in order to carry out the above calibration or correlation steps. As a person skilled in the art will understand, such a computer system can be implemented in any other appropriate hardware, software and/or firmware, or a combination thereof, and can be a single physical entity, or several separate physical entities with distributed functionality.

The computer system 500 may comprise various hardware components, including one or more single or multi-core processors collectively depicted by a processor 501, a memory 503 and an input/output interface 504. In this context, the processor 501 may or may not be included in an FPGA. The computer system 500 may be a “ready-to-use”generic computer system. The computer system 500 can also be distributed between several systems. The computer system 500 can also be specifically dedicated to implementing the present invention. As a person skilled in the art of the present invention can understand, multiple variants as to the way in which the computer system 500 is implemented can be envisaged.

The communication between the various components of the computer system 500 can be activated by one or more internal and/or external buses 505 (for example a PCI bus, a universal serial bus, a “FireWire” IEEE 1394 bus, an SCSI bus, a Serial ATA bus, an ARINC bus, etc.), to which the various hardware components are electronically coupled.

The input/output interface 504 can make networking capabilities such as wired or wireless access possible. By way of example, the input/output interface 504 may comprise a network interface such as, but without being limited to, a network port, a network connector, a network interface controller, and the like. Multiple examples of way in which the networking interface can be implemented will become apparent to a person skilled in the art of the present invention.

The memory 503 can store code instructions 508, such as those forming part, for example, of a library, of an application, etc. which can be loaded into the memory 503 and executed by the processor 501 in order, for example, to implement the calibration or correlation steps according to the present invention. The memory 503 can also store a database 509, for example the database generated in the above calibration step. A person skilled in the art will understand that the database 509, the code instructions 508 and generally the memory 503 can also reside physically outside the computer system 500, still within the scope of the present invention.

The input/output interface 504 can make it possible for the computer system 500 to be put into communication with other processors via a connection 510. This may be the case, for example, if the above calibration step is implemented in the computer system 500, whereas the above correlation step is implemented in a processor outside the computer system 500, for example on the aircraft.

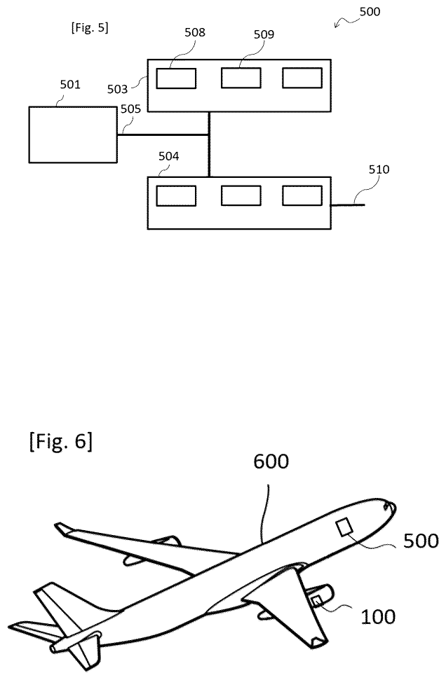

The aircraft 600 depicted in FIG. 6 comprises an air vent 100 to which the present invention is applied in order to estimate the air flow passing through it in flight. The aircraft 600 also comprises an on-board computer system 500 in which the above correlation step can, for example, be implemented.

Although the implementations described above have been described and depicted with reference to particular steps executed in a particular order, it will be understood that these steps may be combined, subdivided or reordered without departing from the teachings of the present disclosure. At least some of the steps may be executed in parallel or in series. Consequently, the order and grouping of the steps do not constitute a limitation of the present invention.

Modifications and improvements to the implementations described above of the present invention may appear to a person skilled in the art. The above description is illustrative through examples rather than limiting. The scope of the present invention is therefore limited solely by the scope of the below claims.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. A method for estimating air flow through an air vent of an aircraft, the air vent having at least two pressure sensors being positioned along a pressure measurement extraction line on or near a lip of the air vent, the method comprising:
a calibration step comprising:
i) applying at least two air streams to an air vent successively, each air stream having at least two characteristics, a first characteristic being velocity and a second characteristic being incidence of said air stream with respect to the air vent, wherein values of the at least two characteristics of each air stream are known;
ii) for each of the at least two air streams applied to the air vent, measuring a corresponding pressure distribution along a measurement extraction line; and
iii) generating a reference database associating, respectively, for each of the at least two air streams applied to the air vent, the values of the at least two characteristics and pressure distribution measurements along the measurement extraction line; and
a correlation step, comprising:
i) measuring a pressure distribution along the measurement extraction line when the aircraft is in flight; and
ii) correlating a measured pressure distribution with the values of the at least two characteristics of the air stream passing through the air vent in flight from the reference database in order to estimate an air flow passing through the air vent when the aircraft is in flight.

2. The method according to claim 1, wherein at least one of the at least two air streams of the calibration step is applied by an actual physical test to the air vent.

3. The method according to claim 1, wherein at least one of the at least two air streams of the calibration step is applied to the air vent by computer simulation.

4. The method according to claim 1, wherein correlating the measured pressure distribution with the reference database comprises an extrapolation.

5. The method according to claim 1, wherein the calibration step further comprises:
using all or some of data from the reference database in order to feed a neural network, and train the neural network by machine learning to provide a trained neural network; and
wherein the correlation step further comprises:
feeding the trained neural network with the measured pressure distribution, associated with the values of the at least two characteristics of the air stream passing through the air vent in flight, the trained neural network inferring an estimate of the air flow passing through the air vent when the aircraft is in flight.

6. A non-transitory computer readable medium comprising instructions for executing the method according to claim 1.

7. An aircraft air vent comprising:
at least two pressure sensors being positioned along a pressure measurement extraction line on or near a lip of the air vent,
the air vent being equipped with a reference database obtained by a calibration step comprising:
applying at least two air streams to the air vent successively, each air stream having at least two characteristics, a first characteristic being velocity and a second characteristic being incidence of said air stream with respect to the air vent, the at least two air stream characteristics being known;
for each of the at least two air streams applied to the air vent, measuring a corresponding pressure distribution along the measurement extraction line; and
generating the reference database by associating, respectively, for each of the at least two air streams applied to the air vent, values of the at least two characteristics and measurements from the corresponding pressure distribution along the measurement extraction line.

8. The air vent according to claim 7, wherein the at least two pressure sensors have a minimal projection with respect to the lip of the air vent.

9. The air vent according to claim 7, wherein the at least two pressure sensors are ultra-fine pressure sensors embedded in a perforated lip of the air vent.

10. The air vent according to claim 7, wherein the at least two pressure sensors are pneumatic sensors.

11. An aircraft comprising:
the air vent according to claim 7; and,
a processor configured to:
measure a pressure distribution along the measurement extraction line when the aircraft is in flight; and
correlate a measured pressure distribution with the values of at the least two characteristics of the air stream passing through the air vent in flight from the reference database in order to estimate the air flow passing through the air vent when the aircraft is in flight.
